(19) United States
(12) Patent Application Publication
(10) Pub. No.: US 2016/0247360 A1
(43) Pub. Date: Aug. 25, 2016

(54) GAMING SYSTEM

(71) Applicant: Score Gaming LLC, Los Angeles, CA (US)

(72) Inventor: Merrill Sparago, Los Angeles, CA (US)

(21) Appl. No.: 15/055,929

(22) Filed: Feb. 29, 2016

Related U.S. Application Data
(63) Continuation of application No. 13/631,445, filed on Sep. 28, 2012, now abandoned.
(60) Provisional application No. 61/540,214, filed on Sep. 28, 2011.

(51) Int. Cl. G07F 17/32

(52) U.S. Cl. CPC G07F 17/3293; G07F 17/3213; G07F 17/322

(57) ABSTRACT

A modified blackjack card game uses standard playing cards. If the dealer hand sum is 2-15, the dealer must take an additional card. If the dealer hand sum is 16-21 all wagers are resolved. A player's wager is won if their hand sum is higher than the dealer's. The player's wager is pushed if the dealer's sum is 16 and the player's sum is less than 22. An optional Double Up wager allows the player to increase the value of their primary wager without accepting any additional cards into their hand. The game rules can be modified to allow an automatic player win if their hand value is exactly 16 and the numerical sum of the dealer's hand is between 17-21. Optional Community and Poker-Style side wagers enable players to offset traditionally frustrating bad hands.

### CROSS REFERENCE TO RELATED APPLICATIONS

This application claims priority to U.S. patent application Ser. No. 13/631,445 filed Sep. 28, 2012, which claims priority to U.S. Provisional Patent Application No. 61/540214 filed Sep. 28, 2011, the entire disclosure of which is hereby incorporated by reference and relied upon.

### BACKGROUND OF THE INVENTION

1. Field of the Invention

The current invention relates to a gaming system for facilitating play of a card game, and more particularly to a specially configured gaming table and a specially configured electronic gaming machine.

2. Related Art

The casino industry is constantly in demand of new games that will improve player enjoyment, increase the amount of time players spend at the table and thereby improve revenue. There are many avenues to acquire new games to offer casino patrons. One direct approach is to modify well-established games by identifying frustrating situations for players which tend to drive them away from the table, and then limiting the occurrence of these frustrating situations through rule modifications thereby increasing player enjoyment and time spent at the tables.

In order for any given rule modification to be effective it needs to be uniquely crafted and implemented in a way that will: Preserve the essential elements of the original much-loved game; Keep a house edge; Require the same number of wagers as the traditional game; Maintain balance for the house and player (i.e. may alter winnings but prevent loses); Preserve guaranteed winnings for the player on certain hands; Keep traditional bonus systems in play afforded on the main wager; Introduce new bonus systems in the play of the main wager; Offer new opportunities for the player to win in favorable situations to neutralize and overcome perceived advantages the rule modification provides the house; Turn potentially losing situations into neutral or winning situations; Limit the frequency of hands that players expect to win and then lose; Allow players to increase their wagers in favorable situations after they know the final composition of their hand; and Provide the player with increased strategic options.

Blackjack is a much-loved traditional card game. The traditional rules of blackjack delicately maintain a small house edge. In general, rule modifications that increase the house edge make it more likely the dealer will make a hand or will limit player opportunities. Examples of rule variations which increase the house edge include the dealer hitting on soft 17 (i.e. in situations where a card sum of 17 is composed of an ace that has been ascribed a numeric value of 11), instead of standing on all 17's. This example rule modification unfavorably minimizes the opportunities for the player to double down their wager, and decreases the traditional payout of bonus hands. In order to offset the unfavorable aspects of a rules modification like this, other rule changes to blackjack might be needed such as minimizing the number of decks used in the game, providing guaranteed winners, allowing more opportunities to double a wager, and taking multiple cards on aces, and other steps that favor the player. It will be appreciated that even small rules modifications can have significant impacts on the overall ability of a game to preserve the subtle combination of qualities that make it a traditional favorite.

It should go without saying that in order to be truly viable, any rule variation must be mathematically sound and always contain a house edge. Proposed variations in the method of play of games that are mathematically non-viable have no genuine and/or long-term value in the market place. Since blackjack has a small house edge (about 1%) there is not much opportunity for a rule variation that gives the player an additional advantage yet maintains a commercially viable house edge. Therefore very creative strategies are required to preserve the house edge and meet the requirements listed above to improve player experience. Often such creative strategies appear simple in retrospect, despite the fact that they are difficult to conceive.

An example of a rule variation that preserves a house edge but fails to increase player enjoyment and time spent at the tables is found in U.S. Pat. No. 7,506,874 to Hall, issued Mar. 24, 2009 which increases the threshold of a dealer bust from 22 to 23. In traditional blackjack, players automatically win their wager if the dealer's total hand exceeds a point value of 21. However, Hall's modification changes a player's traditional win on a dealer 22 into a push (i.e. the player does not win or lose any money). The dealer must reach a total of 23 to bust, thereby giving an edge to the house. The method described in U.S. Pat. No. 7,506,874 takes a player's winning hand in traditional blackjack and turns it into a push. It changes the pay of the player's hand by taking away a guaranteed winner, but does not change the play of the dealer's hand. In itself, this change confers no perceived value or advantage to the player as there is no situation where a dealer 22 would ever result in a player loss in traditional blackjack.

Unique methods of altering the game of blackjack must adroitly maintain or increase the house edge while simultaneously increasing player enjoyment and time spent at the tables. There is therefore a need for a new rule modification to the beloved traditional blackjack game that: Can be favorable to the player or the house, instead of just the house; Can turn a possible losing hand into a hand where no money is lost, (rather than changing a winning hand into a hand where no monies are won); Allow the player to make a single traditional wager to participate in the game; Offer the player an opportunity to continue to employ traditional basic strategy and adopt new strategies; Preserve the standard payouts if desired; Offer opportunities for additional bonuses on the main wager during the course of play; Are not based on changing the threshold for busting and therefore do not take away a player's winnings; Can reduce the occurrence of frustrating situations where players expect to win but instead lose, and of primary importance, can allow for the player to be paid for hand totals of 21 on the primary wager, double down, split, and side wagers thereby increasing the enjoyment of the game; Change the pay and play of the dealer's hand, rather than just the pay of the hand, as changing the play of the dealer's hands introduces a new set of strategies; Can change strategies which are consistent with the basic strategy of blackjack thereby preserving the essence of the play and concomitant decisions the player will need to employ to be successful in the game; and Allow players to wager more monies in favorable situations.

### SUMMARY OF THE INVENTION

A gaming table is configured to facilitate play of wagering games similar to blackjack utilizes one or more decks of standard playing cards. A game playing surface establishes playing positions for a dealer and at least one player. A touch-screen device is located at each player position. The touch-screen device is configured to display a standard deck of 52 playing cards. The cards have respective faces designated in ascending numerical values 2-10, J, Q, K, A each in four suits. A numerical value is assigned to each card. The numerical value is equivalent to the face value for cards designated 2-10, and ten for cards designated J, Q, K, and either one or eleven for cards designated A. According to the method, a primary wager is accepted from the player at the start of play. The player and the dealer are then each dealt two initial cards. The two initial player cards are arranged face-up, whereas the initial dealer cards are arranged so that one card is face-up and the other card is face-down. The player is invited to receive one or more additional cards so long as the numerical sum of card values in the player hand does not exceed 21. If at any time the numerical value of the player's hand exceeds 21 then the player's primary wager is resolved in favor of the dealer. The initial face-down dealer card is exposed after the player has indicated an unwillingness to receive additional cards. With both initial dealer cards exposed, the numerical sum of the dealer hand is calculated. If the numerical sum of the dealer hand is less than 16, then the dealer is required to receive an additional card following which the calculating and requiring steps are repeated. If on the other hand the numerical sum of the dealer hand is greater than 15, then the primary wager is resolved. The step of resolving the primary wager includes comparing the numerical sum of the dealer's hand to the numerical sum of the player's hand, and settling the player's primary wager in favor of the player if the numerical sum of the player's hand is higher than the numerical sum of the dealer's hand and the numerical sum of the dealer's hand is not 16. The player's primary wager is pushed if the numerical sum of the dealer's hand is exactly 16 and the numerical value of the player's hand is seventeen through twenty. The player's primary wager may be paid along with bonus wagers, split wagers and double down wagers if the total of the player's hand is 21. If the total of the player's hand is 22 or greater the player's primary wager is lost and collected by the house.

The game table enables the unique ability to pay a player's wagers when they reach a total of 21 is a vast improvement on prior strategies used to increase the house edge. For example, in the play of a hand of blackjack if a player is dealt a two-card total of eleven (such as with a seven and a four), they often employ the strategy of doubling down to try and win more monies. To double down the player places an additional wager equal to the primary wager and receives one card, hoping for a ten valued card for a total of 21. If the player achieves this total and their wager was a push based on altering the play of the dealer's hand this would be extraordinarily frustrating for the player given the player has achieved the highest hand secondary to a blackjack. The improvement herein allows for the player to be paid on their 21 if the dealer has a total of 16 and thereby increases enjoyment and positive expectation for winning when the player has a 21.

According to another aspect of this invention, an electronically implemented method of playing the wagering game uses images of playing cards. An electronic gaming machine includes at least one display screen configured to display images of playing cards. The electronic gaming machine includes a non-transitory computer readable medium coded with instructions and executed by a processor to perform the steps of the game method as described above.

The present game system enables an alteration in the traditional game of blackjack in a commercially viable way for the casino while increasing player enjoyment and time spent at the tables.

### BRIEF DESCRIPTION OF THE DRAWINGS

These and other features and advantages of the present invention will become more readily appreciated when considered in connection with the following detailed description and appended drawings, wherein:

FIG. 1 is an exemplary view of a multi-player live game table having touch-screens embedded in the playing surface at each player station, the system including a computerized controller coded with instructions to execute game methods according to this present invention;

FIG. 2 is an exemplary illustration of an electronic gaming machine configured for single-player use in connection with the present invention;

FIG. 3 is an exemplary view of the playing surface of a multi-player live game table configured to facilitate game methods of this invention;

FIG. 4 is a simplified flow diagram providing an overview of the game method play according to one embodiment of the present invention;

FIGS. 5A-5B represent a round of the modified game of blackjack in which three players participate against a dealer;

FIG. 6 depiction another exemplary card games played with three players according to the methods described above to illustrate aspects of the game method;

FIGS. 7A and 7B are parts of the same exemplary flow chart depicting the round of play with the modified rule when the dealer's 16 results in a push and the player is permitted to place a Double Up wager;

FIGS. 8A-8B represent a round of the modified game of blackjack in which three players participate against a dealer and utilize the optional Double Up wager;

FIG. 9A and 9B are parts of the same exemplary flow chart depicting the round of play with the modified rule where all player wagers push on any dealer total of 16 and players win automatically on any 16;

FIG. 10 represents a round of the modified game of blackjack in which three players participate against a dealer and benefit from the optional Player 16 automatic win rule;

FIGS. 11A and 11B are parts of the same flow chart depicting overview of method of play of the modified game where all player wagers push on any dealer total of 16 and players can break down any 3-card hand into a 2-card and 1-card hand;

FIGS. 12A and 12B are yet another depiction of an exemplary blackjack card game played according to the methods described above, and including an optional Community side wager; and

FIG. 13 is a still further depiction of an exemplary blackjack card game including an optional Poker-Style side wager.

FIG. 14 depicts yet another exemplary blackjack card game according to this invention.

### DETAILED DESCRIPTION OF THE PREFERRED EMBODIMENT

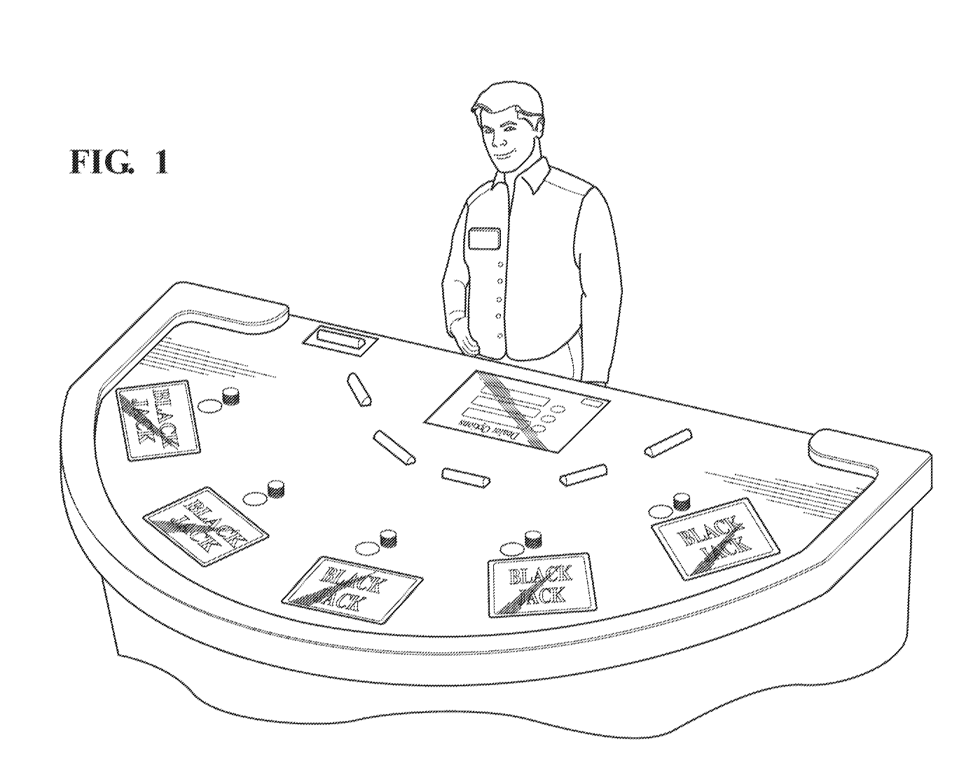

As shown in FIG. 1, the modified card game of the present invention may be played in a casino-type environment with multiple players concurrently playing in the physical presence of one another in real time against a common dealer representing the casino or “house”. The game table of FIG. 1 is of the type having touch-screens embedded in the playing surface at each player station, such as for example the iTable products available from Shuffle Master, Inc. of Las Vegas, Nev., USA. A system like that depicted in FIG. 1 includes a non-transitory computer readable medium coded with instructions and executed by a processor to perform the steps of this present invention. Although the representation in FIG. 1 shows only five player stations, six player stations or more or fewer are possible.

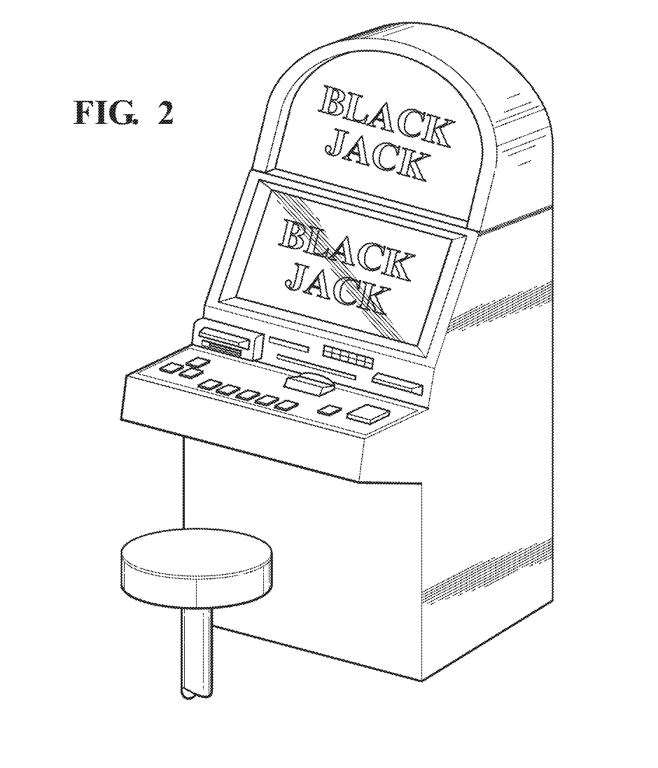

As shown in FIG. 2, the modified card game can alternatively be played in electronic or virtual format, whereby cards are displayed on a screen and dealt by computer or other electronically triggered system based on available technology. The game programming may simulate a dealer or be configured to live-stream activity from a remotely located dealer.

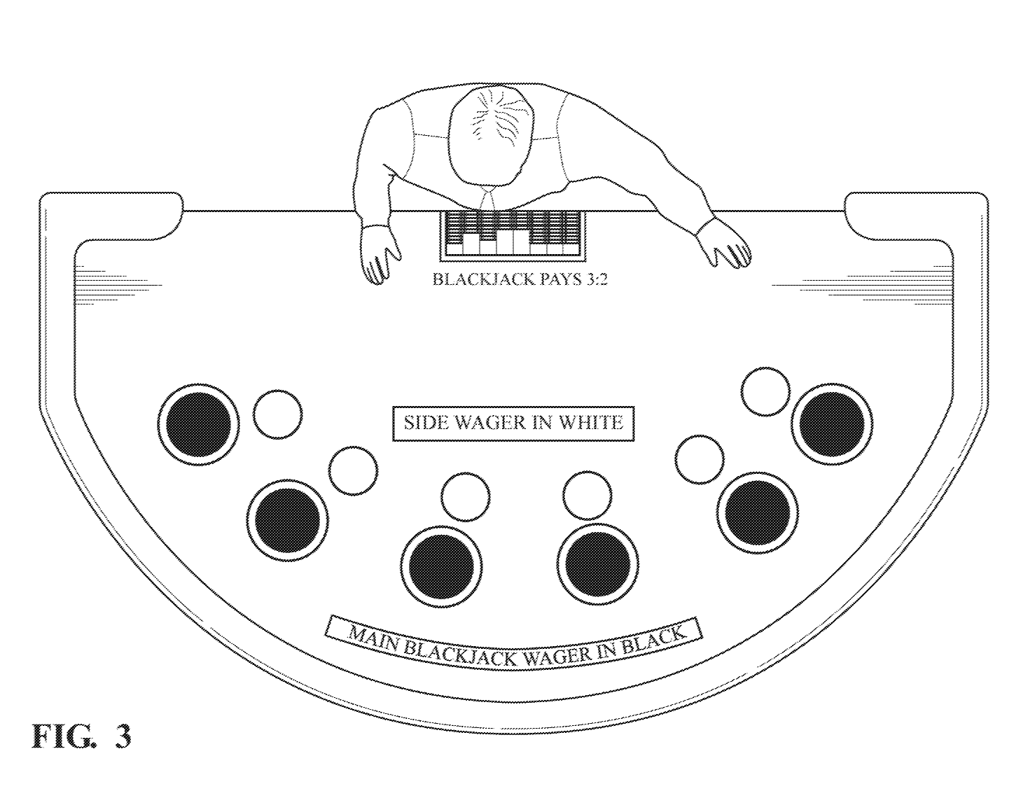

The modified card game may also be played on a standard casino gaming table using a live dealer and a single player or multiple players, as shown in the exemplary layout of FIG. 3. In this scenario, playing cards may be dealt by dealer hand or via an automated dealing machine. Included in the exemplary layout are spaces designated for the dealer and 6 players. Areas to set main and side wagers are demarcated.

Rule changes to traditional blackjack games must be mathematically viable (i.e. preserve a house edge) and also increase player enjoyment. One way to increase player enjoyment is to eliminate a frustrating aspect of the traditional blackjack game. One such frustrating scenario in blackjack arises when a dealer's initial hand shows a 6 as the face-up card. Skilled player know that a 6 can either indicate a great opportunity for win or a great opportunity for loss, since players expect the dealer's unexposed card likely has a value of 10, thereby giving the dealer a total of 16. Dealers must hit all hands of 16 and can often bust. Thus when a dealer shows a 6, basic strategy dictates this is a favorable situation. When the dealer is exposing a 6, players with pat hands of 17-20 expect to win. Hands of 12-16 turn from bad hands to good hands as the player wins with any total less than 21 if the dealer busts. Players who can place additional wagers to double down or split cards seize this opportunity and expect to win more on a dealer up card of 6.

In an example of play of a traditional round of blackjack where the dealer shows a 6, they will often times expose their hole (face-down) card to reveal a 10 valued card (i.e., 10, J, Q or K). Now with a definite dealer 16, players are hopeful to see the dealer bust and collect win their respective wagers. The dealer may then draw a 5 for a total of 21 and win all player hands under 21. Scenarios such as these, where players that are expecting to win and end up losing, can leave players discouraged. Several occurrences of this scenario are likely to drive players away from the table.

This particular dilemma can be more irritating for players when the dealer is showing a 10 and the player has a total of 17-20. Here players expect the dealer's unexposed card to have a value of 10 for a total of 20. If the player has a total of 20, they expect to win or at worst push, but certainly do not expect to lose. If the player has a total of 17-19, they are hoping the dealer does not have a 10 as their hands will lose to a dealer 20. A player with 21 is almost a guaranteed winner as the dealer has already checked for blackjack at the beginning of the round. According to this frustrating scenario, the dealer turns over their hole card to expose a 6, for a total of 16. Now everyone is expecting to win, and the dealer draws another 5 for a total of 21. The emotional swing for players from an expectation of winning to losing/pushing can make suck a player's enjoyment from the blackjack game causing them to leave the table.

Novice blackjack players make up a solid majority of players. Novice players are more likely than experts or more seasoned players to be discouraged by the emotional roller-coaster of rapidly cycling from an expectation of winning to losing. Further, novices are generally not well educated in the mathematical probabilities of any particular final outcome based on the dealer's up card. For example, it is commonly assumed that when the dealer has an up card of 6, the dealer is more likely to bust rather than make a hand of 17-21 out of the original assumed total of 16. In fact, this assumption is faulty. The dealer actually makes a hand 58% of the time and busts only 42% of the time with a 6 as an up card. This means 16% of the times, or approximately 1 in every 6 hands, that a dealer shows a 6 up card the player that expects a win on the basis of a dealer bust will lose due to their faulty assumption. The sense of dashed expectation is often compounded because players tend to place more money on the table when the dealer is showing a 6 by virtue of splitting and doubling down, thus increasing the perception of loss when the dealer does make a hand. Though, players can and do often win when the dealer has a 16, it is loses that drive players away.

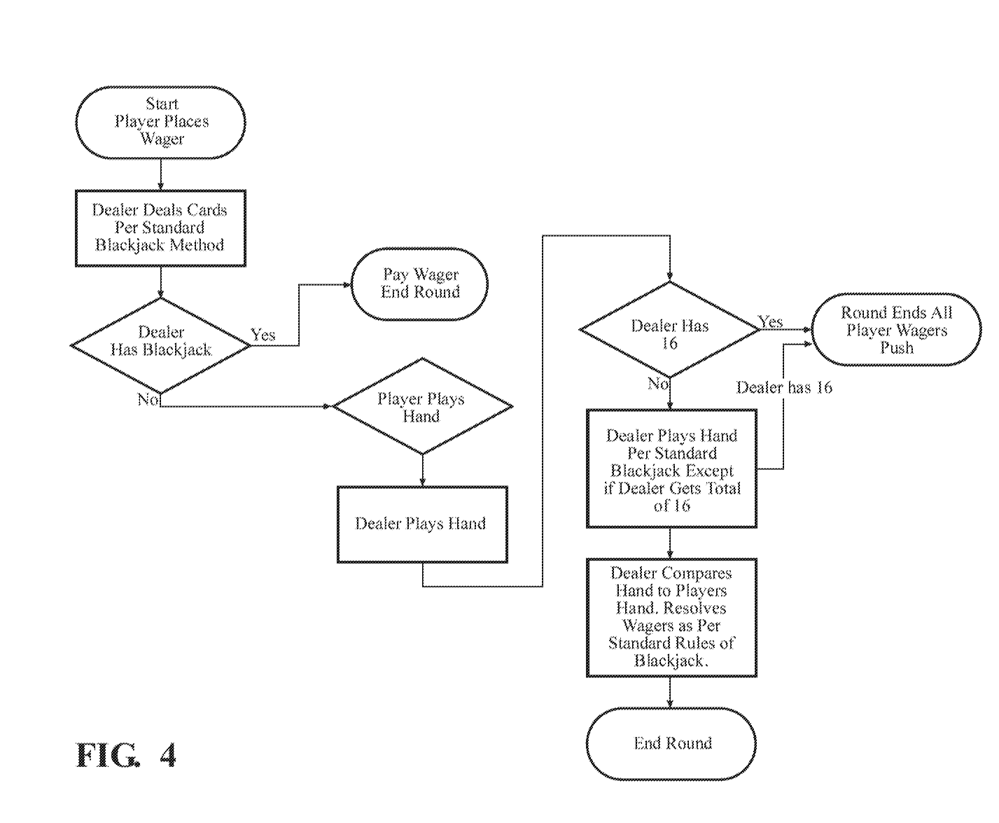

To remove this frustrating aspect of the game, the present invention comprises a rule modification to the traditional game of blackjack that nimbly maintains the house edge while increasing player enjoyment and time spent at the tables. FIGS. 4-6 depict game methods of play according to one embodiment of the present invention in the form of simplified flow diagrams. Simply stated, but by no means simply conceived, the game methods of this invention change the hitting and standing protocol of traditional blackjack where dealers hit on 16. According to this invention, the blackjack card game is played in most materials respects in the traditional way expect that the dealer is required to stand upon reaching any card sum of 16, either hard or soft, whereupon all player wagers are pushed, i.e., returned. All other rules and procedures followed in traditional blackjack are preserved.

This fundamental rule change in both the play and pay of the dealer's hand confers several unique advantages, which include: Player's do not have to lose hands that they are expecting to win; Removes the average player's pre-conceived assumption that a win can be expected with the dealer shows a 6 up card; Frees up the house edge and provides a commercially viable platform for even more rules modifications that enhance the gaming experience; and Opens up new lines of strategy for the player.

The method of play of the modified game includes a dealer and at least one player. The game may be played with a single standard deck of playing cards or multiple decks. As shown in FIG. 4, play begins with the player making a single blackjack wager as in the traditional game of blackjack. The player (along with any other participating players) is then dealt two cards and the dealer receives two cards, one exposed up card, and one hidden down card. The player plays their hand first by virtue of the traditional rules of blackjack which include standing, hitting, splitting pairs, doubling down, or surrendering. Reference to the popular work “Scarne's New Complete Guide to Gambling” by John Scarne, Fireside Publishers, 1986 (ISBN-13: 978-0671630638) is hereby made and relied upon for complete details regarding the traditional rules of blackjack.

Traditional rules include the occurrence of a “blackjack” where the player receives an ace and a ten-valued card on the first 2-cards, thus yielding a numerical card sum of 21. A blackjack is paid at a suggested ratio of 3:2. Players who do not achieve a blackjack are invited to receive additional cards, one card at a time. Receiving an additional card is known as a hit, and the numerical value of each new card is added to the sum of cards previously received by the player in that round of play. Players may request additional cards until their hand total exceeds a sum of 21, in which the hand is a bust and the player automatically loses their wager. The player must therefore use discretion when requesting additional cards to avoid a bust.

After all cards are dealt, if the dealer up-card shows a 10-valued card or an ace, they must check their hole card for the possibility of a blackjack. In the event the dealer's exposed card is an ace, the dealer will offer insurance as per the standard play of blackjack. If the dealer does have a blackjack, they will collect all players wagers who do not also have a blackjack and will return the wager for all players who also have a blackjack (i.e. push). The dealer will pay all players who have placed an insurance wager at the standard ratio of 2:1. The round will end and a new round will start when a player places a wager.

In the event the dealer does not have a blackjack, they will play their hand after all players complete the play of their hands. As outlined in FIG. 4, the game steps including the dealer exposing their hole card. As stated previously, the present invention includes a rule that when the numerical sum of cards in the dealer hand is equal to 16, the dealer will stand and end the round and return all player's wagers who do not have a total of 21. Players with a total of 21 will be paid at the customary rate of 1:1 on the main wager and all secondary wagers. Therefore, if the numerical value of the dealer's original 2-cards totals 16, the dealer will stop play and return all player wagers except those players who have a total of 21, who will be paid 1:1 on their wager. Conversely, if the dealer's card sum is less than 16, the dealer will take additional cards until either: 1) The total of the dealer's hand is exactly 16, with an ace counted as either a 1 or 11, at which time play stops and all player wagers are returned, or 2) the total numerical value of the dealer's hand is between 17-21, or 3) the total numerical value of the dealer's hand exceeds 21 (busts). The outcome of the player's wager will be determined by the dealer comparing the total of the dealer's final hand to the player's final hand using standard blackjack rankings.

Assuming the player and dealer do not have a blackjack, the player will win their wager if either: the card sum of their hand outranks the dealer's card sum, or the total of the dealer's hand exceeds 21. The player will push their wager (i.e. the players wager will be returned to them) if either: the total of the dealer's hand is 16 and the total of the player's non busted hand is any value less than 21, or the total of the dealer's hand and the players hand are in the range of 17-21 and are equal (i.e. tie). The player will lose their wager if: the sum total of the dealer's hand outranks the player's hand, or the total of the player's hand exceeds 21. After all wagers are resolved and cards are collected, the next round of play will begin with at least one player placing an initial blackjack wager.

The modified rule of pushing wagers when the dealer has a card sum of 16 beneficially supports a change in basic player strategy. If a player cannot lose to a dealer 16, the player can be more aggressive when the dealer shows a 6. Similarly, when the player has the opportunity to double down and they receive a bad card (i.e. player has 2-card total of 11, doubles down and receives a 2 for a total of 13), the player cannot lose their wager on the dealer making a hand between 17-21 if the dealer reaches an exact total of 16. Players can also be more confident when standing on a low 2-card total when the dealer is showing a 6, as the dealer cannot beat the player if they have a 16.

Additionally, with the present modified rule, a dealer's up card of an ace becomes less powerful. Under standard rules of blackjack, a dealer will achieve a hand of 17-21 83% of the time when showing an Ace. However, with a dealer push on 16, this takes away hands the dealer would make from any soft or hard totals of 16. Thus, if the dealer shows an Ace and the unexposed card is a 5 this is a soft 16, which can easily turn into a powerful dealer hand if they were allowed to play on per the traditional rules of blackjack.

In the scenario where the dealer shows an ace and has an unexposed card of 2, the dealer has a soft 13. If the dealer draws a 10 this is a hard 13, if the dealer were then to draw a 3 the total would be hard 16 which would by standard rules afford the dealer an opportunity to make a hand using 5 of the 13 cards in the deck (i.e. A-5). With this present rule modification, players are not given the chance to win on a dealer 16, but they also cannot lose. Thus, this can be a favorable situation for the player.

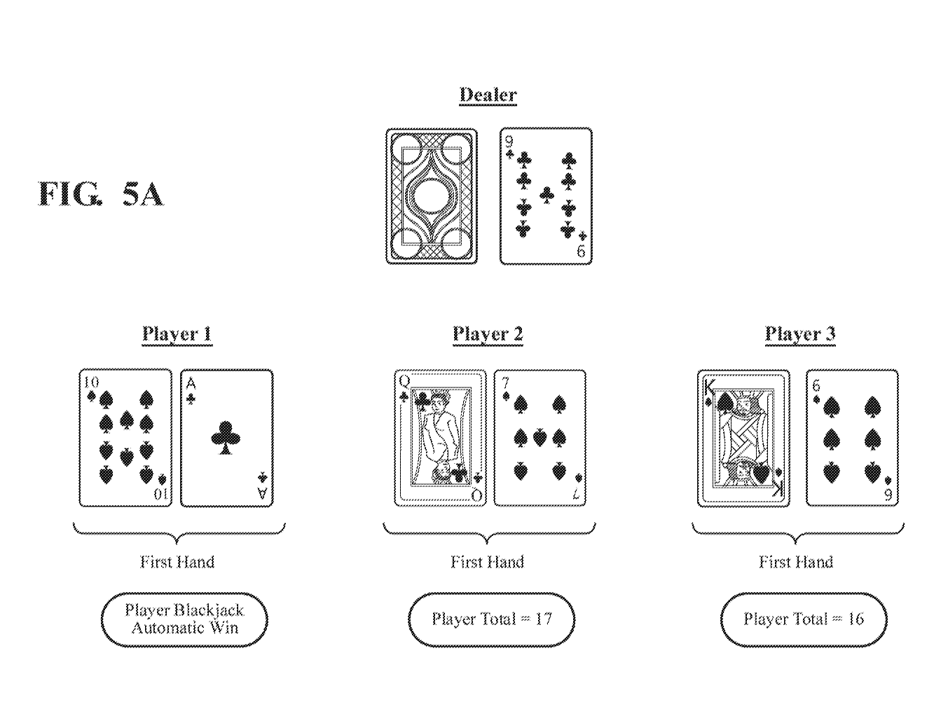

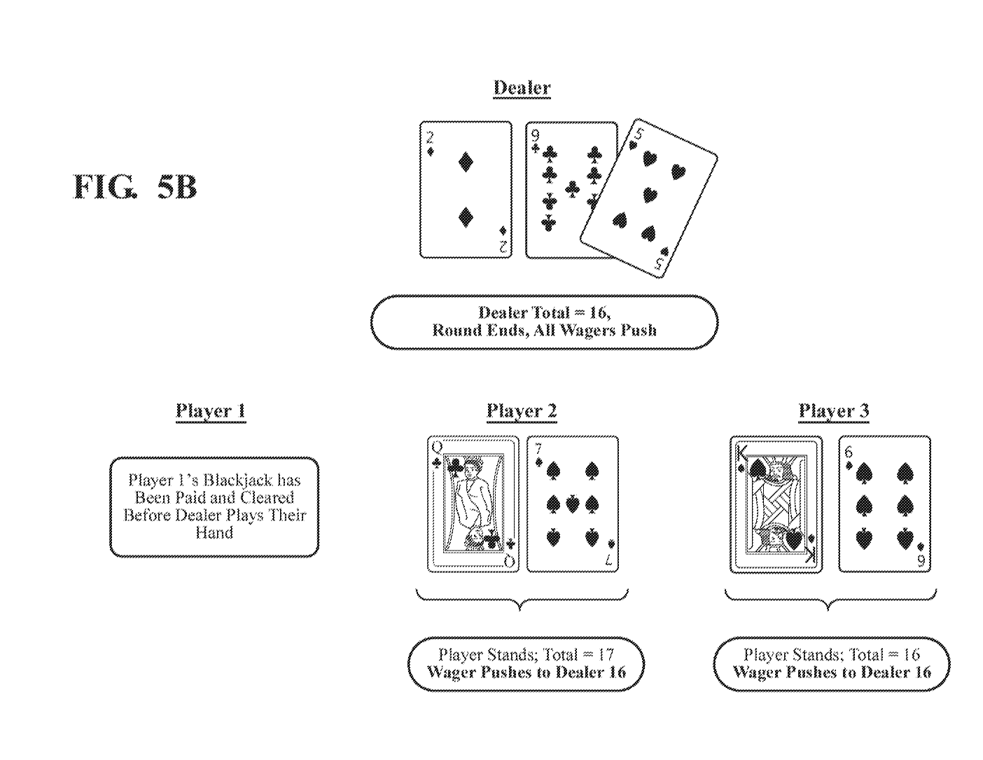

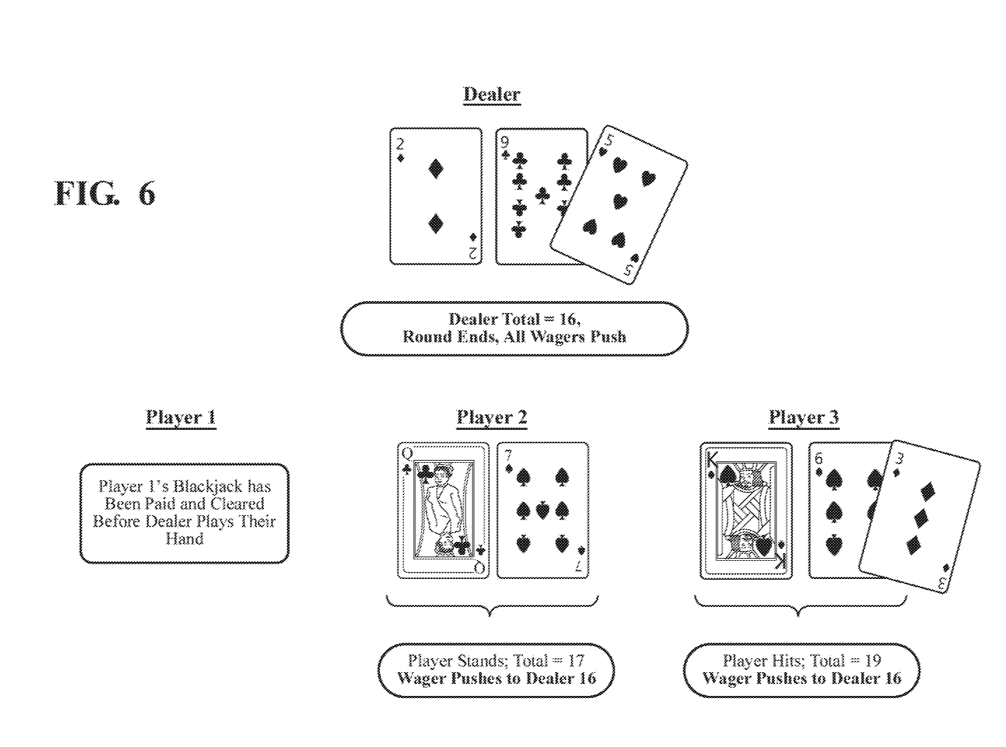

FIGS. 5A-5B represents a round of the modified game of blackjack in which three players participate against a dealer. Player 1 is dealt a blackjack and is an automatic winner. The dealer shows a 9. Player 2 is dealt a card sum of 17 (Q-7) and stands. Player 3 is dealt a card sum of 16 and stands. Dealer reveals their hole card as a 2, resulting in a card sum of 11. Dealer takes a hit, receiving a 5 for a total of 16. According to the modified rules of this game, all unresolved wagers, i.e., all wagers except Player 1, push. For illustrative purposes, FIG. 6 shows the same card game of FIG. 5B, but in this alternate scenario before the Dealer played his hand Player 3 hit on 16 to receive a 3 card, thus elevating the Player 3 card sum to 19. Nevertheless, Dealer's ultimate card sum of 16 trumps Player 3's card sum of 19, and Player 2's card sum of 17, to result in a push against those players.

In another example, consider five players at a blackjack table. During a round of play, after the initial two cards are dealt the dealer is showing a 6. All players complete their hand, and the dealer exposes a 10 for a total of 16 and the round ends. If in the next round, the next card out of the shoe is a 5, players will have saved a significant amount of money as the dealer was precluded from taking this 5 for a total of 21 in the previous round. This would be an example of using the method of play to spare the player from a dealer 21 and losing monies in a situation they would have expected to win.

Adding this present rule alteration in both the play and payout of a dealer 16 returns some edge to the house, in that the dealer does not bust on 16's. Other rules and methods of play can then be added to further modify the game of blackjack while keeping the essential principles and bonus payouts of traditional blackjack.

### Optional Double Up Wager

The present invention further allows for more unique wagering opportunities to be added to the game of blackjack. One such wagering option is the referred to herein as “Double Up”, it being understood that the term Double Up is a fanciful name coined by the applicant and used herein for the sake of clarity and brevity. The term Double Up is not to be construed as a generic or merely descriptive term applicable to the novel game methods described and claimed herein.

The game of blackjack is limited in options when the player has a pat hand of 17-20 on their first 2-cards as the best play is for the player to stand. Hitting on 17 and above would always be the wrong play as the likelihood of busting far exceeds the likelihood of making a hand. Similarly, after a player splits pairs such as two 9's and receives a 10 on both cards (for two card sum totals of 19) there is no further wise strategy and the wise player stands on both hands. Thus standing is the only sensible option for players who have a hand of 17-21. Extending this basic premise one step further, knowledgeable players will not take a hit on 2-card totals of 13-16 if the dealer is showing a 3-6 as an up card. Again, the options are limited as the player can simply stand and wait for the dealer to play their hand.

According to an alternative embodiment, the modified rules of this invention may include an option for a player to double their initial wager on any 2-card hand, without taking any extra cards. Thus instead of simply standing, the player can place more money on their hand without drawing any additional cards. In this alternative form, a player still places an initial blackjack wager. The player(s) and dealer are dealt two cards each. All other rules of standard blackjack still apply, however all player blackjacks and 21's will win automatically. Blackjacks pay at a bonus of 3:2.

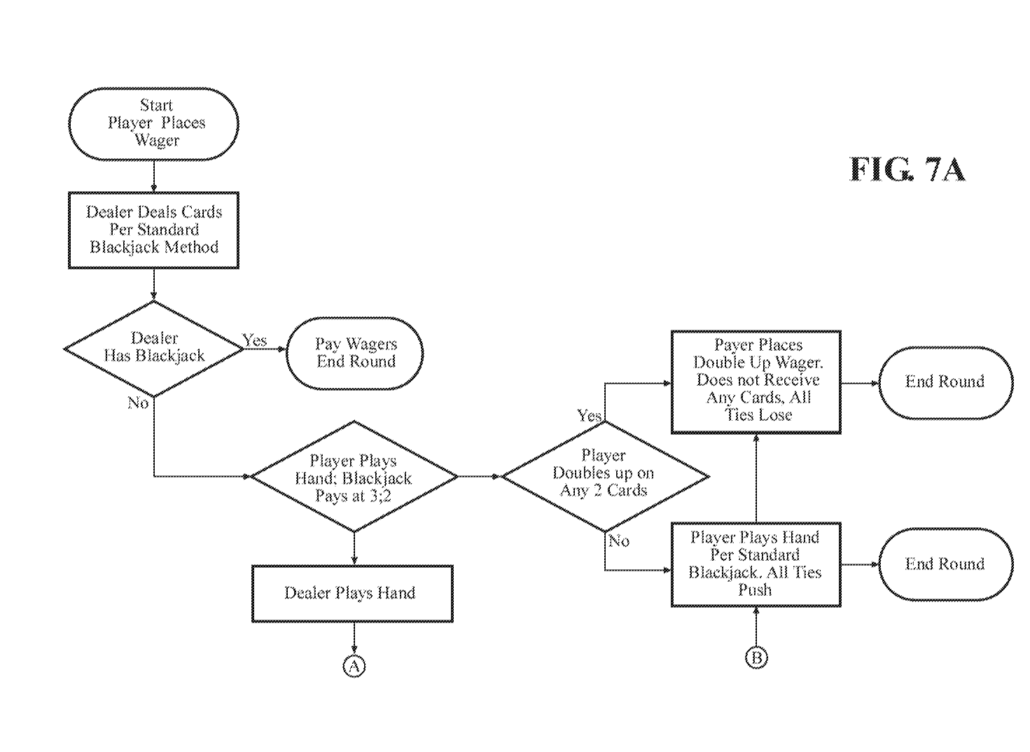

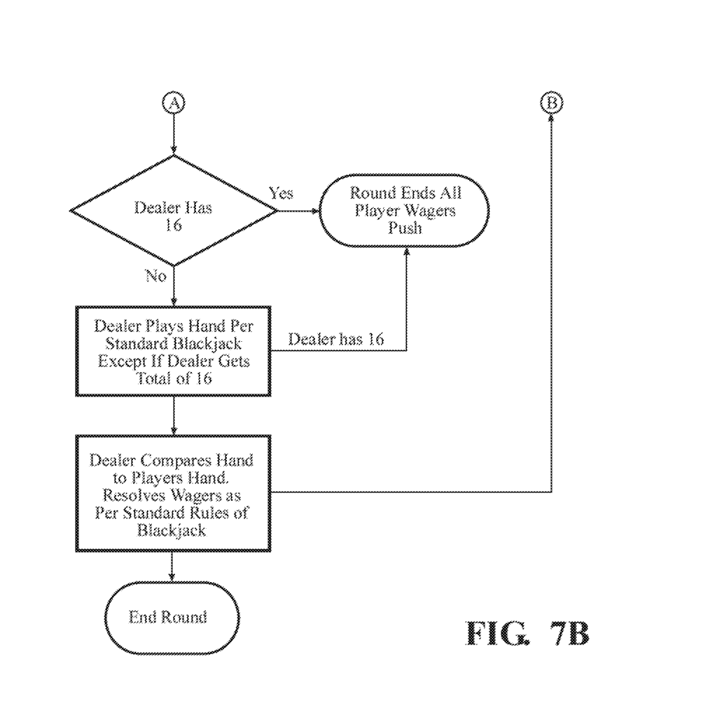

FIGS. 7A and 7B provide an exemplary flow chart depicting the round of play with the modified rule where the player is permitted to place a Double Up wager. After all cards are dealt, the players are invited to place an optional second wager (the “Double Up” wager) of any amount up to (but not exceeding) the total of their main wager. After placing the Double Up wager the player does not receive any additional cards, and play moves to the next player or the dealer. Instead of just standing on a hand, player strategy can include a determination whether or not to double their wager and then stand. Thus, the optional “Double Up” wager adds another dimension of strategy and excitement to the traditional game of blackjack.

Doubling Up is distinguished from doubling down as used in the traditional sense. When a player doubles down, the player places an additional wager and then receives 1 card. Therefore the player must wager more before knowing the final total of their hand. This leaves two unknown variables after the player places a double down wager—the final composition of the player's hand and the final composition of the dealer's hand. In contrast, with the Double Up option, players have the opportunity to increase their wager by up to 100% on the basis of knowing with certainty the exact sum total of their hand. This takes away one of the unknown variables in the traditional double down wager and only leaves the final total of the dealer's hand as an unknown. And so, when a player has a strong 2-card hand against a dealer's weak hand, the player can stand and alter their initial blackjack wager in the range of up to 2×. The optional Double Up wager thereby adds another decision to the traditional game of blackjack that successfully maintains the house edge while simultaneously increasing player enjoyment and time spent at the tables.

Since the player can double their wager on any two cards, players can also Double Up on two-card hands that result from splitting pairs. As indicated above, basic strategy dictates that a player should split a pair of nines against a dealer 8, going for a total of 19 after splitting and doubling their money. If the player splits the nines and indeed does receive a 19 they have a 2-card total of 19, which is a strong hand against a dealer 8. In traditional blackjack the player's only option at this point is to stand. In the current version of the modified game, the player also has the option of Doubling Up on their initial wager after getting the nineteen and not taking any additional cards.

The option to Double Up on any 2-cards becomes even more powerful when the player receives a pair of aces on their first 2-cards. Basic strategy dictates that a player should always split aces against any dealer up card as the player can receive a 10 valued card on each ace for 2 hands that total 21. Players are indeed excited when they split Aces and receive a 10.

The outcome of the Double Up wager will be determined by comparing the dealer's final hand with the player's final hand. To win the Double Up wager, the player's 2-card hand total must exceed that of the dealer. If the player's 2-card hand total is of equal or lower value than the dealer's they will lose the Double Up wager. This is in contrast to the main blackjack wager which will be returned if the dealer's hand and the player's hand are of equal value.

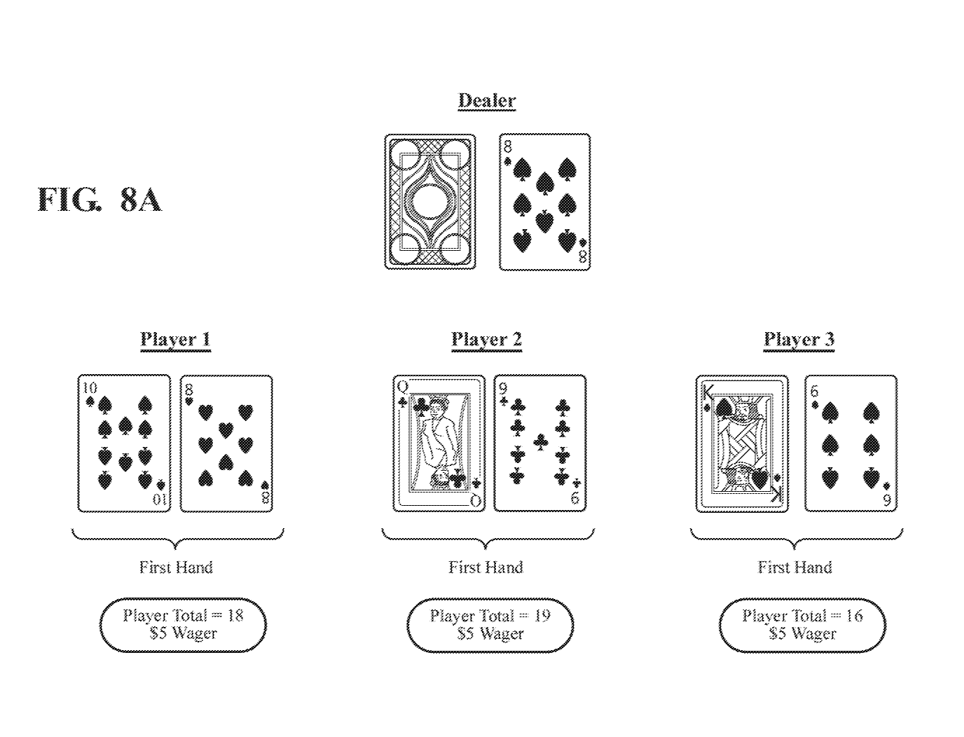

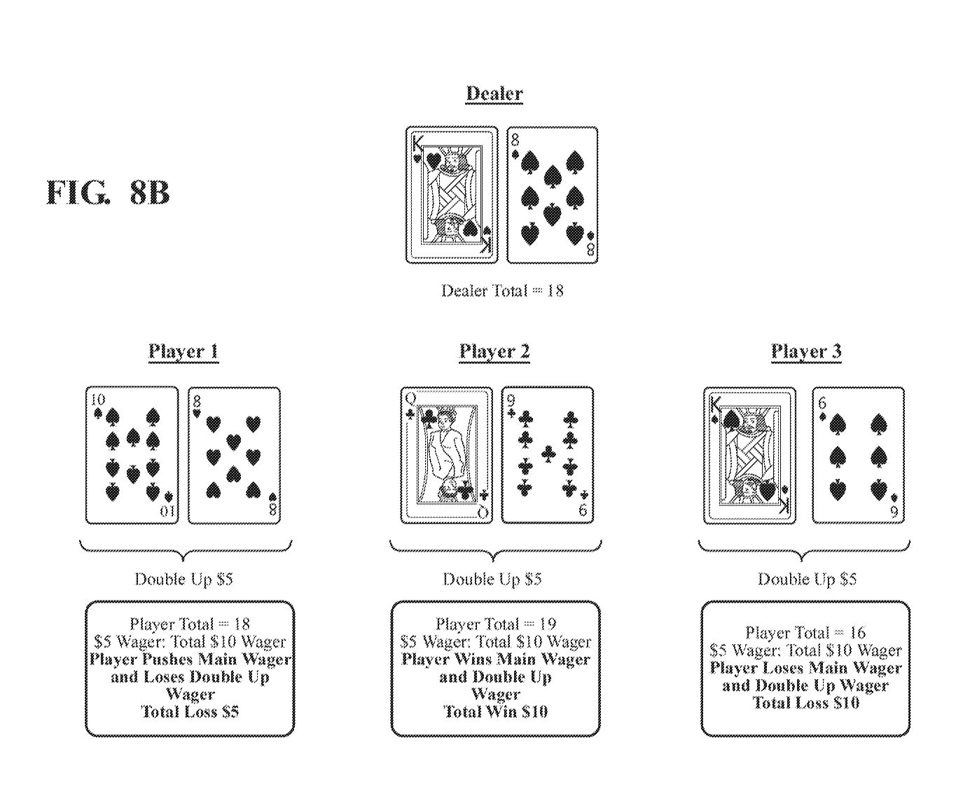

FIG. 8A-8B represent a round of the modified game of blackjack in which three players participate against a dealer and utilize the optional Double Up wager. In this example, the dealer shows an 8. Player 1 received a K-8 and signals a Double Up so as to stand with 18 while simultaneously doubling his $5 wager so that now $10 is at risk. Similarly, Player 2 received a Q-9 and signals a Double Up so as to stand with 19 while simultaneously doubling her $5 wager so that now $10 is at risk. Player 3 received a K-6 and also signals a Double Up so as to stand with 16 while simultaneously doubling her $5 wager so that now she has $10 at risk. In resolving these various wagers, Player 1 pushes on their main wager and loses the Double Up wager—net loss $5. Player 2 wins both their main wager and their Double Up wager—net win $10. Player 3 loses both their main wager and their Double Up wager—net loss $10.

Bonuses can be added to the main wager whereby all 21's win automatically. Further, depending on the embodiment, players will get a payout of either 1:1, 2:1 or 3:2 on a 2-card 21. A 2-card 21 is distinguished from a blackjack in that a blackjack can only occur on the first 2-cards. A 2-card twenty-one can only occur by splitting pairs of aces and receiving a 10, or splitting a pair of tens and receiving an ace.

The bonus structure of the modified game provides an advantage and enhanced perceived value. As such, 2-card 21's do not pay at a bonus and can push to a dealer 21 in traditional blackjack. In further distinction, the only bonus a player can receive is when they get an ace and a 10 valued card on their first two hands. This is expanded on in the current modified game, as the player is in certain embodiments paid a bonus of 2:1 or 3:2 on 2-cards 21's. An alternate bonus can be contained in the rules as the hand of 2-card 21 always wins and can never push. Again this takes out another frustrating part of traditional blackjack (i.e. pushing player 21's to a dealer 21). Now the main wager can be paid at a bonus ratio for a blackjack, and also for a 2-card 21 if the player does not receive a blackjack, but uses their original hand to construct a 2-card 21.

The Double Up wager adds a novel strategy component to basic strategy. As indicated above unlike the main wager, the Double Up wager will lose to a dealer tie. Since the wagers have different thresholds for winning, different strategies need to be used to decide whether the Double Up option is the right play. A basic strategy chart for play of the Double Up wager can be developed which can be used in conjunction with simple basic blackjack strategy.

As an example of the play and pay of the Double Up wager, assume that a player has placed an initial wager of $5 and received for his first two cards a jack and a 9 for a sum total of 19. If the dealer shows an 8, the player could Double Up and stand on their 19. If the dealer's hole card is a 10, resulting in a card sum of 18, the player would win both their main wager and their Double Up wager. In another example, if a player has a 2-card hand of 18 against a dealer 8, the player could Double Up, receive no additional cards and hope to beat the dealer. If the dealer's unexposed card is a 10 for a total of 18, (or the dealer made any other hand of 18 through a combination of more than 2-cards) the player and the dealer would tie. Here, the original wager plays by the standard rules of blackjack where all ties push and the wager is returned to the player. However, since the player's card sum of 18 did not beat the dealer's total of 18, the player would lose their Double Up wager. Strategically, if the player expects a tie, it would not be a wise strategy to Double Up. Double up wagers are best used when the player has a high expectation of winning. In a new example, the player had a 2-card total of 18 and the dealer is showing a 7. The player might assume the dealer has a total of 17, i.e., that a 10 valued card is in the hole. This would be a good opportunity to Double Up as the player's 18 beats a dealer 17 and if the assumption is true the player would win both their initial wager and Double Up wager.

An exemplary round of play with 2 players (player 1 and player 2) and a dealer can further illuminate the novelty of combining the rules of player wagers pushing to a dealer 16, and being able to double (i.e. Double Up) an initial wager. As such, Player 1 and Player 2 both make an initial wager of $5. Player 1 receives a king and a queen for a total of 20. Player 2 receives a pair of aces. The dealer is showing a 9 as their up card.

Player 1 has a high expectation of winning with a 20, and therefore takes advantage of the Double Up option by placing a second $5 wager in a designated spot on the table. Player 1 must also signal the dealer through verbal or hand signal (recommended player puts their thumb up) to indicate they will be Doubling Up.

Player 2 has a pair of Aces, which they decide to split. Player 2 places an additional $5 wager and receives a 9 on the first Ace giving the player a total of 20. Player 2 decides to stand and not to Double Up. Player 2 receives a 10 on the second Ace which combines for a 2-card total of 21. Player 2 is automatically paid 2:1 or 3:2, which is $10 or $7.50 respectively on the second five dollar wager.

Play then turns to the dealer who reveals their hole card which is a 7, giving the dealer a total of 18. All players beat the dealer and win 1:1 on both their main wagers and Player 1 wins 1:1 on their Double Up wager.

In another example, including a single player and a dealer, the player places a $5 wager and is dealt a queen and 5 for a total of 15. The dealer has an up card of 5. The player decides to Double Up, and places an additional $5. The dealer reveals their hole card which is an ace for a total of 16. In the modified game all dealer 16's result in the end of the round, and the all wagers are returned to the player. In summary, the addition of the Double Up wager to the modified game where all dealer 16's end the round and all wagers push meet the predefined criteria of: Being favorable to the player or the house; Could turn a possible losing hand into a hand where no money is lost; Allowing the player to make a single traditional blackjack wager to participate in the game; Offering the player an opportunity to continue to employ traditional basic strategy and adopt new strategies; Preserving the standard 3:2 payout for a blackjack; Offering additional bonuses on the main wager outside of a blackjack; Not changing the threshold for dealer busting; Eliminating some frustrating situations where players expect to win and end up losing; Change the pay and play of the dealer's hand; and Allow players to stand and wager more monies after seeing their initial 2-card hand in favorable situations without the player having to take additional cards after wagering additional monies after receiving their initial 2-cards. In this way, players risk more when their final hand is a known quantity rather than risking more money, hoping to draw a favorable card.

### Optional Player 16 Automatic Win

In keeping the above principles in mind, another modification of traditional blackjack can be implemented when the dealer returns all wagers on a total of 16. In general, 16's are the worst hand a player can get, as they are in general losing hands and have a high statistical chance of busting. In general, when a player gets dealt a 2-card hand that totals 16 they often expect to lose. At times the player can draw a small card to make a hand of 17 or better, but this hand also has to beat the dealer. Conversely, the player can stand and hope for a dealer bust.

One particularly frustrating hand to the average blackjack player is being dealt a pair of 8's for a total of 16. Basic strategy dictates to always split 8's against any dealer up card. When the dealer is showing a 9 or a 10 valued card it is difficult adding another wager to a hand you expect to lose (assuming the likelihood is that split 8 hands will each receive a 10-value card). Though, basic strategy calls to split 8's under these circumstances, this does not increase a players chance of winning, it only has them lose less in an infinite deck model. The real world however is based on finite decks, finite time, and a finite bankroll whereby losing less is the long run is not necessarily relative in the moment.

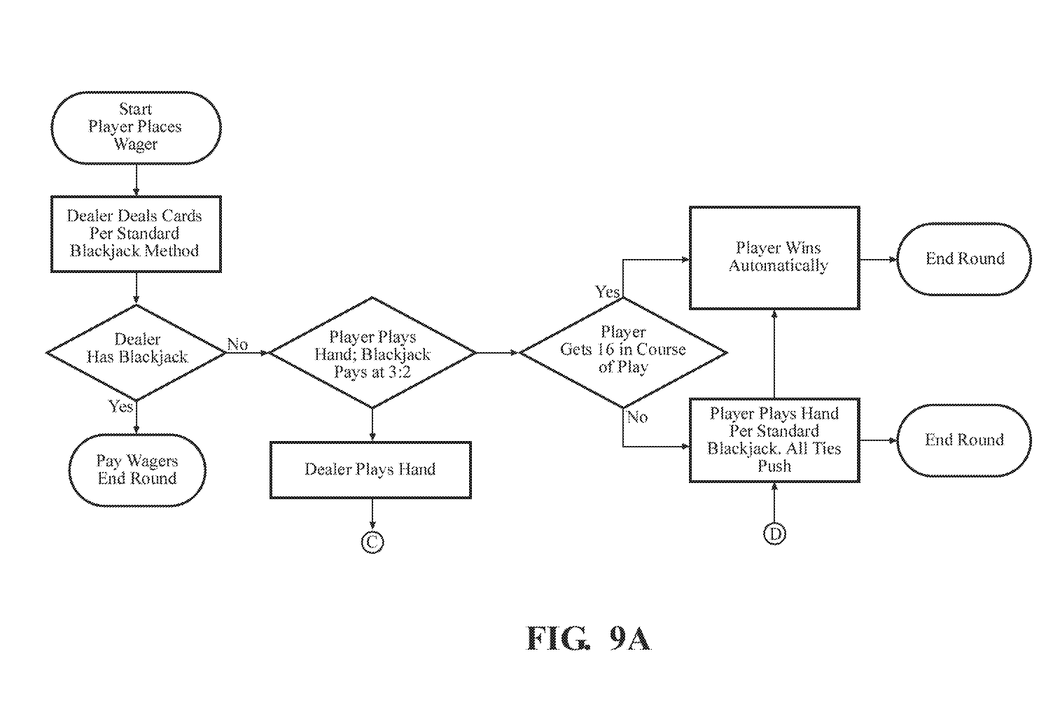

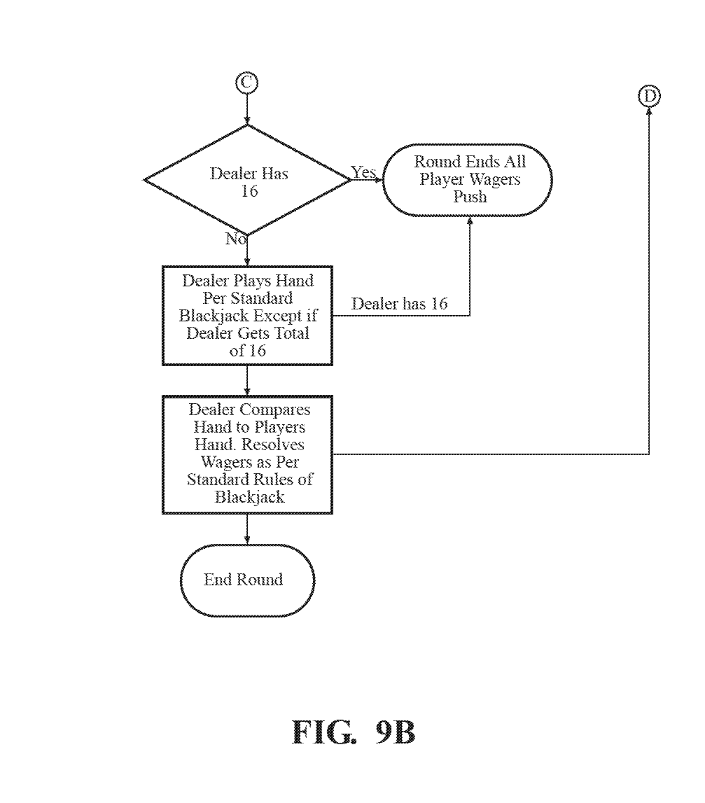

In combining the rule of all dealer 16's result in a push, with a rule that specifies any player 16 is an automatic 1:1 win, a modified game is created where players no longer lose on an undesirable hand of 16, whether it be the player's hand or the dealer's hand. FIGS. 9A and 9B illustrate this optional variation where all player wagers push on any dealer total of 16, but on any player total of 16 that player wins automatically. According to this method of play, player blackjacks may pay 3:2 and win automatically. The rules may be varied still further to provide that any hand of 21 wins automatically. This, in conjunction with the dealer standing on 16, makes a player card sum of 21 a guaranteed win, and players cannot push a 21 to a dealer 21. This further variation removes yet another frustrating part of the traditional game that arises when a player makes a hand of 21 only to push their wager as the dealer also makes a hand of 21.

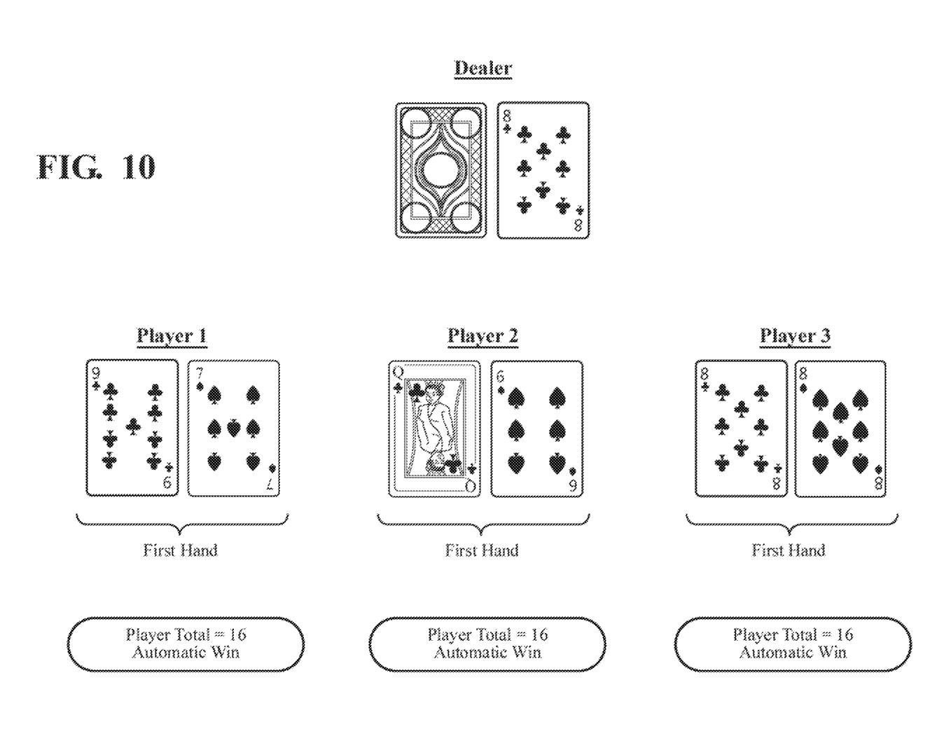

FIG. 10 represents a round of the modified game of blackjack in which three players participate against a dealer and benefit from the optional Player 16 automatic win rule. As shown, before the Dealer's hole card is revealed all three players are seen to win with a card sum of 16 in much the same manner as any of them would have automatically won with a blackjack.

A delightful observation of the rule changes represented by the present invention is that the worst 2-card player hand in blackjack (i.e., a 16) is transformed into a winning hand, increasing player enjoyment and perceived value of the game, and that this option is built into the main blackjack wager rather than a side wager whereby the player is forced to make a second wager to get the benefits of automatically winning on hands other than blackjacks. By way of example, assume that two players each place a $5 blackjack wager. The dealer then deals two cards to each player and two cards to them self per the traditional method of blackjack. In this example Player 1 is dealt a hand of 2 and 5 for a total of 7; Player 2 is dealt a 10 and a 9 for a total of 19. The dealer is exposing an up card of 10. Player 1 hits and receives a 5 for a total of 12, then hits again and receives a 4 for a total of 16. In traditional blackjack, this would be a horrible hand for the player and would have a very high chance of losing. Instead, in one embodiment of the rules of the modified game, Player 1 wins 1:1 on their 16, and ends up winning $5 on their original $5 wager. Player 2 stands on 19. The dealer then reveals a jack for a total of 20. Player 2 loses. However, this is expected as the dealer is assumed to have a 20 with an up card of 10. Player 1 with a 16 is a winner, which by comparison with Player 2 (who lost with a 19) is a celebrated outcome that encourages (rather than discourages) all players to play longer.

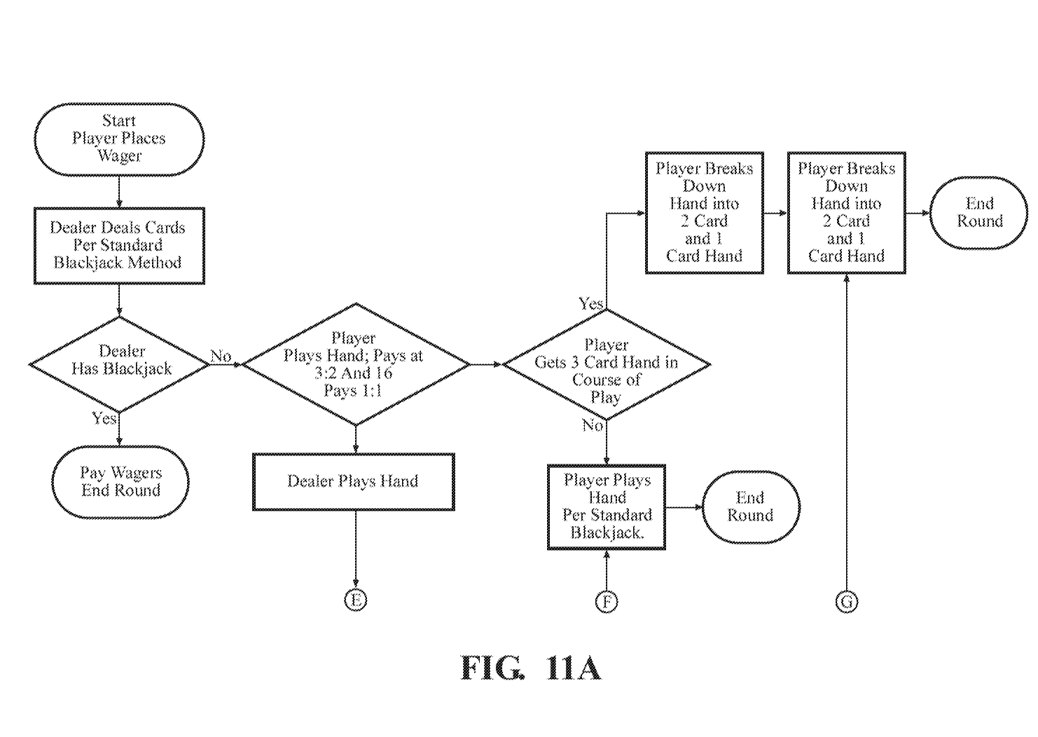

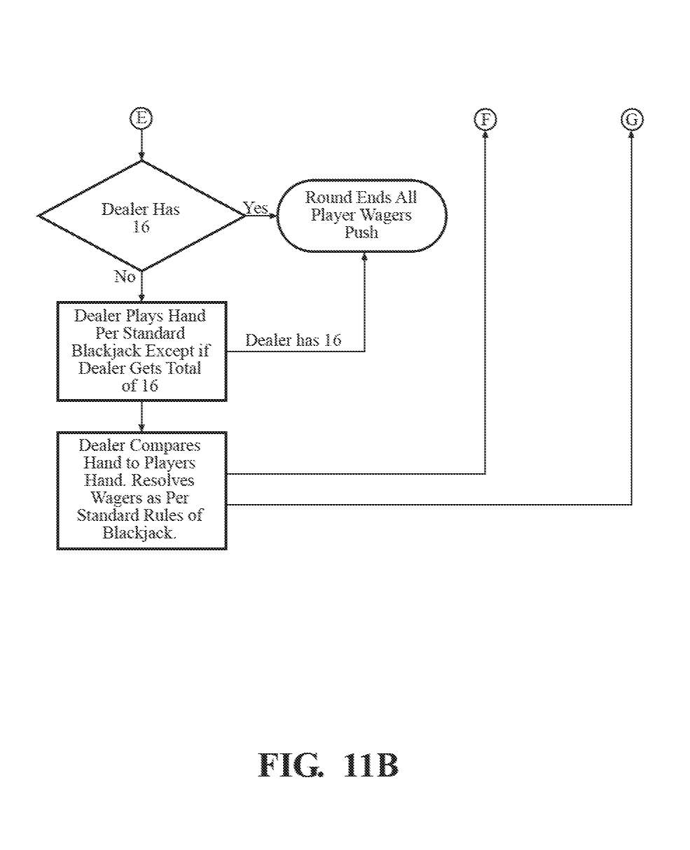

In another version of the modified game, players can have the option of “breaking down” any 3-card hand they receive in the course of play. The procedure for breaking down a 3-card hand is with reference to US 2011/0300918 published Dec. 8, 2011, the entire disclosure of which is hereby incorporated by reference and relied upon. FIGS. 11A and 11B depict the general of method of play of this variation of the modified game in the form of a flow chart. In this variation, all player wagers push on any dealer total of 16 and players can break down any 3-card hand into a 2-card and 1-card hand. Similar to the method described in US 2011/0300918, if a player wants to breakdown a 3-card hand into a 2-card hand and a 1-card hand, they must forfeit their original wager and place 2 wagers of equal value to the original wager. The player then plays 2 hands of this present modified blackjack beginning with the 2-card hand, then when complete moving to the 1-card hand. Players complete their hand as per the any of the modified forms of blackjack described herein.

For example, a single player places a $5 wager to start the game. In this exemplary round the player is dealt a 9 and a 2 for a total of 11. The dealer shows an up-card of 8. The player elects to double down and places an additional $5 wager and receives an ace for a total of 12.

Since the player doubled down they can only stand with their 12 and hope for the unlikely bust. The dealer turns over their hole card which is a 9 for a total of 17, and the player has lost $10. However, according to the present version of the modified game, instead of standing on 12 the player could have chosen to forfeit their $10 wager, and divided their hand into a 2-card hand and a 1-card hand. In order to accomplish this, the player is required to forfeit their original $10 wager and place two new wagers equal to the forfeited wager (i.e., two new $10 wagers—one wager corresponding to the 2-card hand and the other wager corresponding to the 1-card hand). If the player splits their hand like this, they might choose to place the ace and 9 in the 2-card hand for a total of 20, and place the 2 in the 1-card hand. The player stands on their 20 in the 2-card hand. Attention then moves to the 1-card hand which contains a 2. The player draws an 8 for a total of 10 and opts to double down drawing a 9. The dealer (in this example) ends with a total of 17 so that the player wins both hands. When all wagers are settled, the player enjoys a net win of $20 as compared with a net loss of $10 had they chosen not to split their 3-card hand when it was valued at 12.

It is a frustrating fact that player's often bust with only 3 cards in their hand. The preceding method can be employed to permit busted 3-card hands to be broken down. Since a busted hand is a lost wager, the player would have to place 2 more wagers of equal value to the busted wager. The cards can be divided as per the breakdown procedure and played as per the traditional rules of blackjack. This again could turn a losing hand into a player winner.

### Optional Side Wagers

Casino gaming continues to be an exploding industry with a constant demand for novel games and additional wagering opportunities to enhance the excitement and profitability of games. Wagers that are added to standard games such as blackjack are known as side wagers.

Most such side wagers are made available to the player only when they have already won or possess favorable hands that would likely win anyway. For example, in U.S. Pat. No. 5,695,192 to Brown a blackjack game is configured with an optional Craps-based side bet. According to this game method, a player must have a blackjack and beat the dealer to become eligible to place a Craps wager and roll the dice. In another example, there exists a game method of play where the player can make an initial blackjack wager and an optional side wager, betting on the outcome of the dealer's hand whereby if the dealer busts the player will win on their side wager. Since a dealer bust is already a player win (provided the player has not busted first) then this optional side wager is in essence an opportunity to win again on top of a previous win.

What is still needed in the art is a variety of wagering options that turn unfavorable situations into opportunities for a player to offset losses and possibly achieve a net win. Such a construct would be both advantageous for the player and the house as it encourages players to stay at the table longer by removing frustrating loses. Further, side wagers with a graded pay table can result in a player net profit if they win the side wager and lose the main wager. Thus a side wager in which a player would win money when they lose their main wager provides the player with a feeling of winning despite losing. Further, side wagers that add a community aspect to the game are also attractive for players.

The present invention includes a plurality of optional methods for playing a card game of blackjack—in both the traditional manner and also according to the modified rules described above—in which a bonus hand/side wager enable a player to offset loss or win when they would have otherwise lost or are likely to lose their main wager. The side wagers described below do not alter the pay or play of the traditional game of blackjack. All methods of dealing, rules, options, and method of resolving wagers remain the same.

### Community Side Wager Based On Player and Dealer Hand

Another frustrating situation occurs when players are repeatedly dealt unfavorable hands that total 13-16. These hands are likely to bust if the player hits, and will not the beat the dealer if they stand in the absence of a dealer bust. However, while one player is losing, another player in the next seat is receiving a string of blackjacks. If the dealer is getting blackjacks as well, then all players are frustrated.

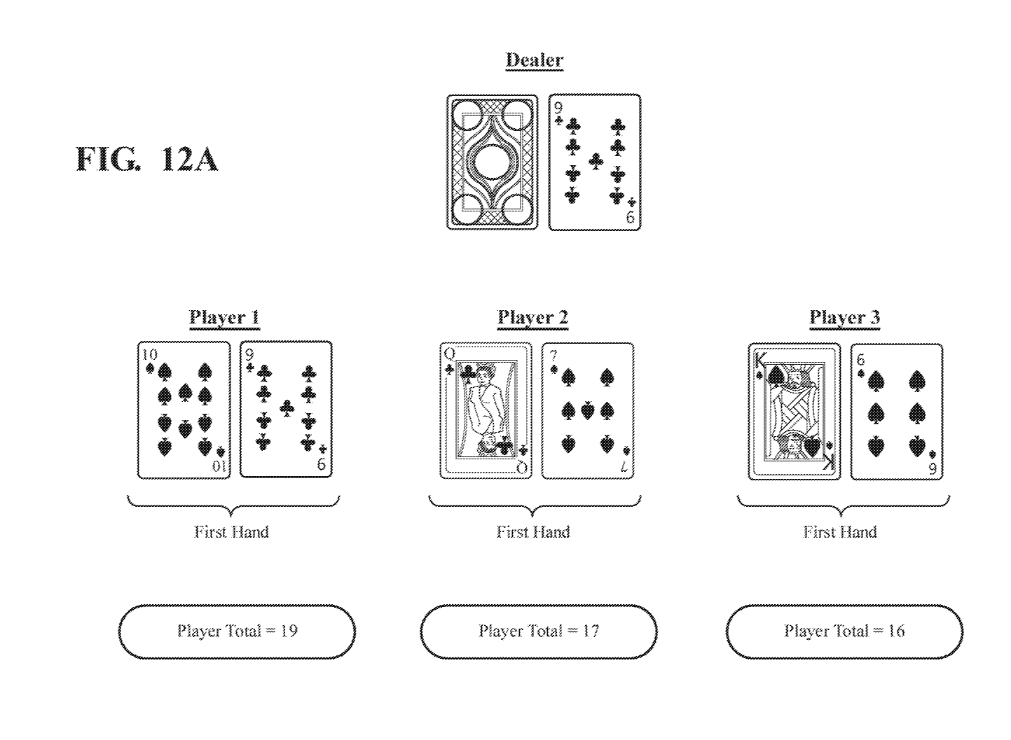

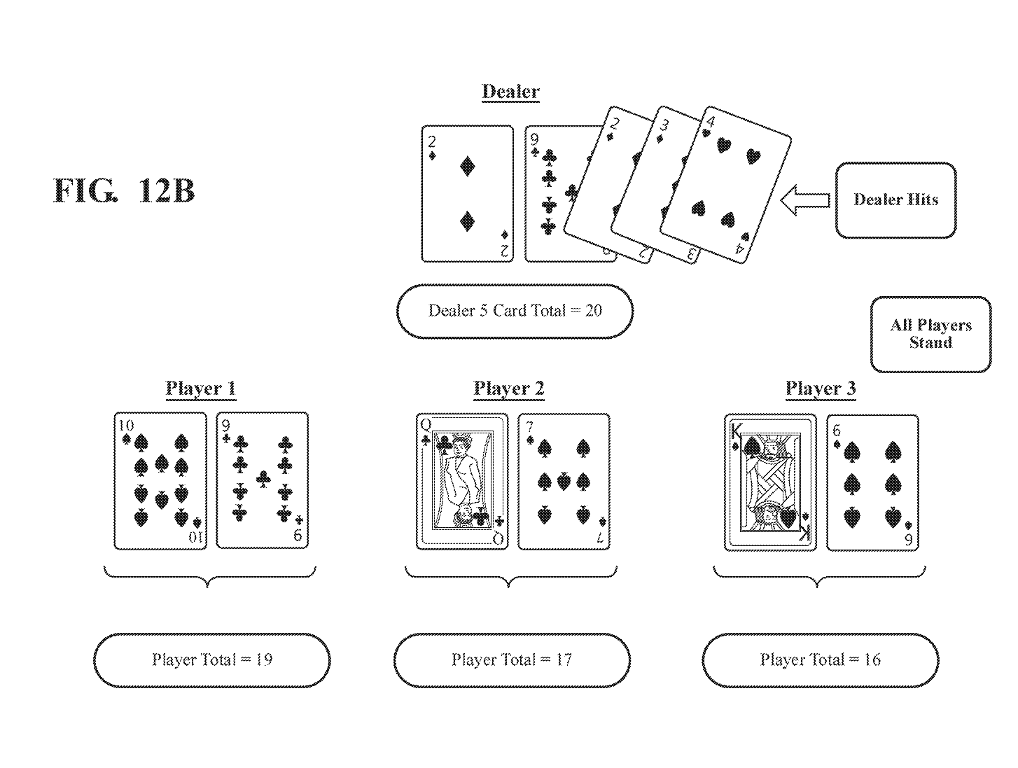

See for example FIG. 12, where according to the traditional rules of Blackjack Player 3 is dealt a hand that most would consider is an unfavorable card sum of 16. Yet Player 1 and the dealer both have blackjacks. The improved Community side wager eliminates this frustrating situation for Player 3. Players who place the optional Community side wager will win money if they, or anyone else at the table (including the dealer) receives a blackjack on the first two cards. This optional Community side wager is therefore dependent upon the number of players at the table. With more players the more likely the wager will win when someone gets a blackjack. This optional Community side wager is advantageous for the house as well as the player.

It is also possible that multiple players receive a blackjack on the same round. In the example of FIG. 12, the dealer gets a blackjack as well as Player 1 resulting in a push on Player 1's main wager. In the case of a dealer blackjack where the exposed card is a 10, the player does not have the opportunity to take insurance protect their wager. In contrast, the optional Community side wager employs a community aspect to blackjack where player's can win off other players, as well as the house's winnings earned through the dealer's hands, putting the player on both sides of the blackjack table. Players lose their Community side wager if there are no blackjacks in a given round.

Player's that choose to do so will place their optional Community side wager based on house minimums and maximums before any cards are dealt. All dealing procedures and play of blackjack remain the same. After all players and the dealer have received their cards, the dealer will inspect their own hand and any other player hands at the table for a blackjack. In the event there is a blackjack on the table the Community side wager will win for those participating players. The Community side wager will pay on a graded scale based on the number of players and the number of blackjacks. The more blackjack there are at the table, the higher the wager pays, even if the player who placed the Community side wager did not receive a blackjack.

Consider a sample round of blackjack with a single player and a dealer. The player places a $5 wager and is dealt two cards, a 10 and a 6. The dealer's exposed card is an ace, and insurance is offered. The player declines insurance and the dealer turns over their hole card which is a queen for a blackjack. In this event the player will have lost their main wager. However, if the player placed the Community side wager, they will win at a suggested ratio of 9:1. Further, if on the same hand that the player also had a blackjack, the Community side wager would pay the suggested ratio of 60:1.

A frustrating situation occurs whenever the dealer has blackjack, and the player also has a blackjack. An even more frustrating situation is when the dealer has blackjack and the player does not have a blackjack. The optional Community side wager rewards the player in these situations at a much higher premium than traditional insurance (which typically pays 2:1). Higher payouts are indicated in situations that would otherwise be very frustrating for the average player. In fact, the payout rate can be coordinated to the perceived frustration level so that the higher the frustration level, the higher the payout. By tempering or offsetting frustrating situations like this at the blackjack table, the average player is more likely to stay at the table and have a more enjoyable gaming experience.

Another sample round includes a dealer and three players. Player 1 is receiving a variety of bad hands and is losing money quickly. Player 2 is also receiving difficult hands and steadily losing money. In contrast player 3 is being dealt a series of blackjacks. The dealer is getting blackjacks as well. With the addition of the Community side wager, all players would be winning, even when the dealer has a blackjack. Players would also be winning more money when they have a blackjack and the dealer had a blackjack as well, as the more blackjacks there are in a round the more the Community side wager pays.

A simple table can be constructed which includes the number of players as well as a number of blackjacks. For each number of players, one through six (or however many seats are available at the table), a separate payout table can be constructed whereby the more blackjacks there are, the larger the payout.

TABLE 1
Exemplary table depicting the pay of the Community side wager with
1 to 6 players and a dealer.

| Number of | Number of Players (All Rounds Include a Dealer) | | | | | |
|---|---|---|---|---|---|---|
| Blackjacks | 1 | 2 | 3 | 4 | 5 | 6 |
| 1 | 8 | 5 | 4 | 3 | 2 | 2 |
| 2 | 60 | 25 | 8 | 6 | 4 | 3 |
| 3 | | 100 | 50 | 40 | 20 | 15 |
| 4 | | | 1,000 | 100 | 50 | 50 |
| 5 | | | | 5,000 | 1,000 | 1,000 |
| 6 | | | | | 5,000 | 5,000 |
| 7 | | | | | | 25,000 |

### Poker-Style Side Wager Based on Player's First 2 Cards

The prior art has taught various poker type side wagers for the game of blackjack. In general, these prior art side wagers either use the player's cards to pay pairs, or have used the player's first two cards in conjunction with the dealer's exposed card to make a three card poker hand. What is needed, however, is an optional side wager based on a 2-card poker hand that takes account of a weak blackjack hand (i.e., initial card sums of 12-16), as well as stronger hands. By focusing on alleviating player frustration, the optional Poker-Style side wager of this invention allows a player to win the optional Poker-Style side wager when they are likely to lose the main wager, or when they have a good hand that is beaten by the dealer. The optional Poker-Style side wager is based on 2-card poker hands which qualify as weak blackjack hands.

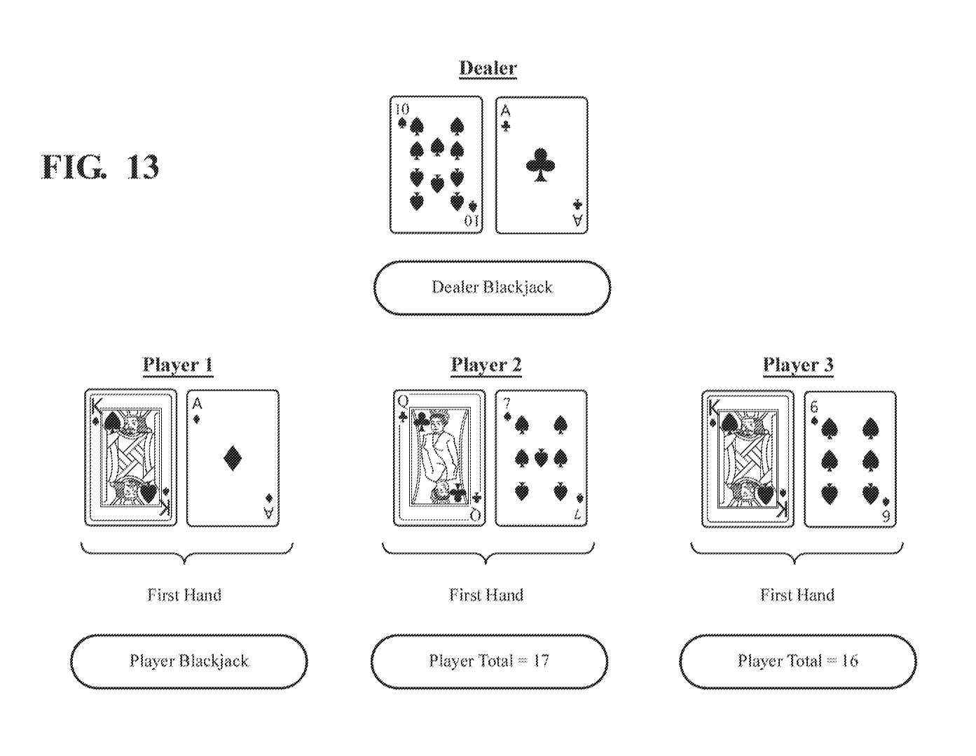

As an example, one might assume a player's 2-card blackjack hand of 10 and 6 for a total of 16 is a likely loser. This scenario is depicted by Player 2 in FIG. 13. However, a 6 and a 10 make the outside ends of a straight (6, 7, 8, 9, 10) in traditional 5-card poker. Constructing an optional side wager around this usually dreaded hand adds an element of excitement to what would otherwise be a source of player frustration. Other outside straights in addition to 6, 10 can include as 5, 9 (card sum total 14) and 4, 8 (card sum total 12). Thus, the optional Poker-Style wager will be won if the player achieves one of these pre-defined outside ends of a straight.

Other hands that fall into the category of unfavorable blackjack hands but that can be viewed as full or partial poker hands include a pair of 8's (I Hates the Eights), as illustrated by Player 3 in FIG. 13. A pair of 8's has a card sum of 16, which as described above is a frustrating hand for players according to the traditional rules of blackjack. Pairs of 6's or 7's are likewise weak hands in blackjack.

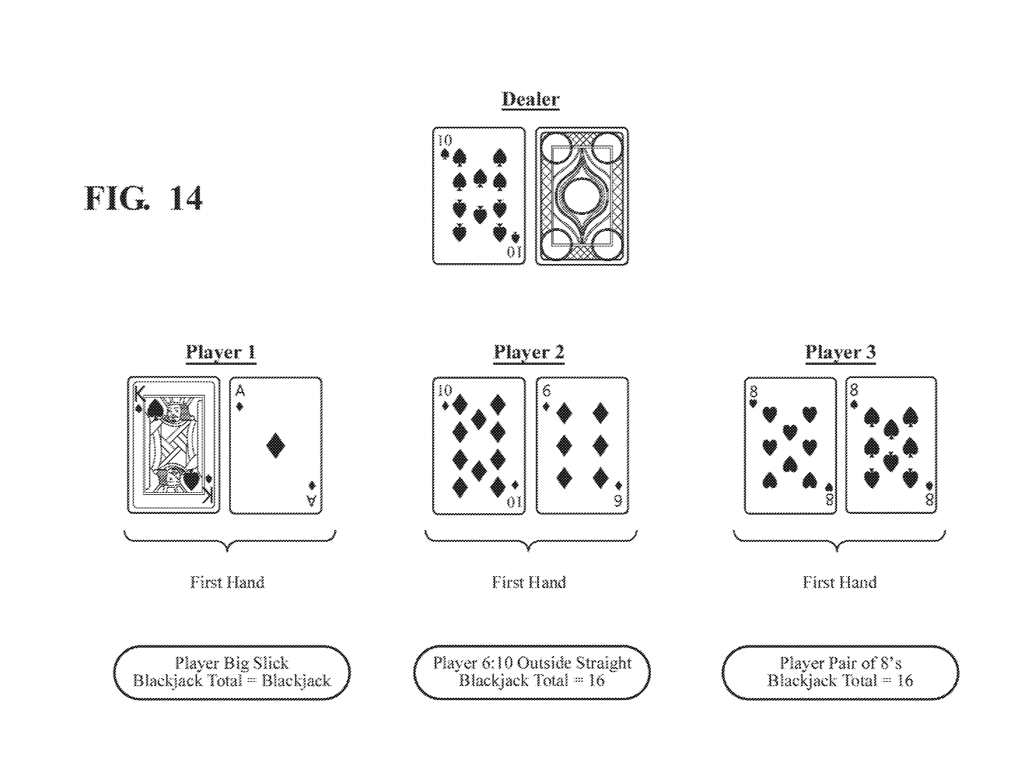

Stronger hands such as the traditional Big Slick (king, ace) or pocket rockets (ace, ace) can also be included in the payout. Player 1 in FIG. 14 is shown with a Big Slick. Thus, it can be said that the optional Poker-side wager that is resolved in favor of the player if the first two cards of the player hand have a numerical sum value in the range of 12-16 and if the first two cards also compose two defining qualities of a traditional winning poker hand.

The optional Poker-Style side wager will push if the player has a blackjack that is not present on the pre-defined Poker-Style side wager pay table. This is to prevent a scenario which would otherwise limit the value of a player blackjack when the player placed the optional Poker-Style side wager. The player makes their traditional blackjack wager and the optional Poker-Style side wager per house minimums and maximums before any cards are dealt. The outcome of the Poker-Style side wager is determined by the first 2-cards. The pay table can be constructed with graded pay for different hands.

The foregoing invention has been described in accordance with the relevant legal standards, thus the description is exemplary rather than limiting in nature. Variations and modifications to the disclosed embodiment may become apparent to those skilled in the art and fall within the scope of the invention.

1.-16. (canceled)

17. A gaming table comprising:
a playing surface having a dealer location and a plurality of player positions;
at least one wagering area associated with each said player position, each said wagering area located on said playing surface;
a touch-screen display affixed to said playing surface adjacent each said player position, each said touch-screen display configured to display images of playing cards;
a non-transitory computer readable medium associated with each said touch-screen display, said non-transitory computer readable medium coded with instructions and executed by a processor to perform the steps of: establishing playing positions on the display screen for a dealer and at least one player; providing electronically producible images of at least one standard deck of 52 playing cards with respective faces designated in ascending numerical sum 2-10, J, Q, K, A each in four suits; assigning a numerical value to each card, said numerical value being equivalent to the face value for cards designated 2-10, said numerical value being ten for cards designated J, Q, K, and said numerical value being one or eleven for cards designated A; accepting a primary wager from the player; dealing the player and the dealer each two initial cards, said dealing step including arranging on the display screen the two initial player cards face-up, said dealing step including arranging on the display screen one initial dealer card one face-up and the other initial dealer card face-down; inviting the player to receive one or more additional cards so long as the numerical sum of card values in the player hand does not exceed 21, if the numerical value of the player's hand exceeds 21 then resolving the player's primary wager in favor of the dealer; exposing on the display screen the initial face-down dealer card after the player has indicated an unwillingness to receive additional cards; calculating the numerical sum of the dealer hand, if the numerical sum is less than 16 then requiring the dealer to receive an additional card and repeating said calculating and requiring steps, if the numerical sum is greater than 15 then resolving the primary wager by comparing the numerical sum of the dealer's hand to the numerical sum of the player's hand and settling the player's primary wager in favor of the player if the numerical sum of the player's hand is higher than the numerical sum of the dealer's hand and the numerical sum of the dealer's hand is not 16, and further pushing the player's primary wager if the numerical sum of the dealer's hand is exactly 16 and the numerical value of the player's hand is anything less than 22.

18. An electronic gaming machine comprising:
at least one display screen configured to display images of playing cards;
a non-transitory computer readable medium coded with instructions and executed by a processor to perform the steps of: establishing playing positions on the display screen for a dealer and at least one player; providing electronically producible images of at least one standard deck of 52 playing cards with respective faces designated in ascending numerical sum 2-10, J, Q, K, A each in four suits; assigning a numerical value to each card, said numerical value being equivalent to the face value for cards designated 2-10, said numerical value being ten for cards designated J, Q, K, and said numerical value being one or eleven for cards designated A;
accepting a primary wager from the player; dealing the player and the dealer each two initial cards, said dealing step including arranging on the display screen the two initial player cards face-up, said dealing step including arranging on the display screen one initial dealer card one face-up and the other initial dealer card face-down; inviting the player to receive one or more additional cards so long as the numerical sum of card values in the player hand does not exceed 21, if the numerical value of the player's hand exceeds 21 then resolving the player's primary wager in favor of the dealer; exposing on the display screen the initial face-down dealer card after the player has indicated an unwillingness to receive additional cards; calculating the numerical sum of the dealer hand, if the numerical sum is less than 16 then requiring the dealer to receive an additional card and repeating said calculating and requiring steps, if the numerical sum is greater than 15 then resolving the primary wager by comparing the numerical sum of the dealer's hand to the numerical sum of the player's hand and settling the player's primary wager in favor of the player if the numerical sum of the player's hand is higher than the numerical sum of the dealer's hand and the numerical sum of the dealer's hand is not 16, and further pushing the player's primary wager if the numerical sum of the dealer's hand is exactly 16 and the numerical value of the player's hand is anything less than 22.
